(19) United States
(12) Patent Application Publication
(10) Pub. No.: US 2026/0101341 A1
(43) Pub. Date: Apr. 9, 2026

(54) SEMI-PERSISTENT SCHEDULING (SPS) FOR VOICE OVER NON-TERRESTRIAL NETWORKS (NTN)

(71) Applicant: QUALCOMM Incorporated, San Diego, CA (US)

(72) Inventors: Ayan SENGUPTA, Mountain View, CA (US); Alberto RICO ALVARINO, San Diego, CA (US); Le LIU, San Jose, CA (US); Xiao Feng WANG, San Diego, CA (US); Syed Hashim Ali SHAH, Littleton, MA (US)

(21) Appl. No.: 19/347,385

(22) Filed: Oct. 1, 2025

Related U.S. Application Data
(60) Provisional application No. 63/703,014, filed on Oct. 3, 2024.

(51) Int. Cl. H04W 72/20

(52) U.S. Cl. CPC H04W 72/20

(57) ABSTRACT

Methods, systems, and devices for wireless communications are described. A user equipment (UE) may receive one or more control messages that indicate both an uplink semi-persistent scheduling (SPS) configuration for voice traffic for the UE and a downlink SPS configuration for the voice traffic for the UE. The UE may receive, in accordance with the downlink SPS configuration, one or more downlink voice packets for the UE via first downlink resources of a plurality of downlink resources indicated by the downlink SPS configuration indicated by the one or more control messages. The UE may transmit, in accordance with the uplink SPS configuration, one or more uplink voice packets for the UE via first uplink resources of a plurality of uplink resources indicated by the uplink SPS configuration indicated by the one or more control messages.

### CROSS REFERENCES

The present Application for Patent claims benefit of and priority to U.S. Provisional Patent Application No. 63/703,014 by SENGUPTA et al., entitled “SEMI-PERSISTENT SCHEDULING (SPS) FOR VOICE OVER NON-TERRESTRIAL NETWORKS (NTN),” filed Oct. 3, 2024, assigned to the assignee hereof, and expressly incorporated herein as if fully set forth below and for all applicable purposes.

### FIELD OF TECHNOLOGY

The following relates to wireless communications, including semi-persistent scheduling (SPS) for wireless signaling such as data or voice over non-terrestrial networks (NTN).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving one or more control messages that activate both an uplink semi-persistent scheduling (SPS) configuration for voice traffic for the UE and a downlink SPS configuration for the voice traffic for the UE, receiving, in accordance with the downlink SPS configuration, one or more downlink voice packets for the UE via first downlink resources of a set of multiple downlink resources indicated by the downlink SPS configuration activated by the one or more control messages, and transmitting, in accordance with the uplink SPS configuration, one or more uplink voice packets for the UE via first uplink resources of a set of multiple uplink resources indicated by the uplink SPS configuration activated by the one or more control messages.

A UE for wireless communication is described. The UE may include one or more memories storing processor executable code, and one or more processors coupled with the one or more memories. The one or more processors may individually or collectively be operable to execute the code to cause the UE to receive one or more control messages that activate both an uplink SPS configuration for voice traffic for the UE and a downlink SPS configuration for the voice traffic for the UE, receive, in accordance with the downlink SPS configuration, one or more downlink voice packets for the UE via first downlink resources of a set of multiple downlink resources indicated by the downlink SPS configuration activated by the one or more control messages, and transmit, in accordance with the uplink SPS configuration, one or more uplink voice packets for the UE via first uplink resources of a set of multiple uplink resources indicated by the uplink SPS configuration activated by the one or more control messages.

Another UE for wireless communication is described. The UE may include means for receiving one or more control messages that activate both an uplink SPS configuration for voice traffic for the UE and a downlink SPS configuration for the voice traffic for the UE, means for receiving, in accordance with the downlink SPS configuration, one or more downlink voice packets for the UE via first downlink resources of a set of multiple downlink resources indicated by the downlink SPS configuration activated by the one or more control messages, and means for transmitting, in accordance with the uplink SPS configuration, one or more uplink voice packets for the UE via first uplink resources of a set of multiple uplink resources indicated by the uplink SPS configuration activated by the one or more control messages.

A non-transitory computer-readable medium storing code for wireless communication is described. The code may include instructions executable by one or more processors to receive one or more control messages that activate both an uplink SPS configuration for voice traffic for the UE and a downlink SPS configuration for the voice traffic for the UE, receive, in accordance with the downlink SPS configuration, one or more downlink voice packets for the UE via first downlink resources of a set of multiple downlink resources indicated by the downlink SPS configuration activated by the one or more control messages, and transmit, in accordance with the uplink SPS configuration, one or more uplink voice packets for the UE via first uplink resources of a set of multiple uplink resources indicated by the uplink SPS configuration activated by the one or more control messages.

In some examples of the method, UEs, and non-transitory computer-readable medium described herein, receiving the one or more downlink voice packets may include operations, features, means, or instructions for receiving, in accordance with the downlink SPS configuration, a downlink message including an indication of a deactivation of at least one of the uplink SPS configuration or the downlink SPS configuration.

In some examples of the method, UEs, and non-transitory computer-readable medium described herein, a medium access control-control element (MAC-CE) includes the indication.

In some examples of the method, UEs, and non-transitory computer-readable medium described herein, the downlink message includes a subpacket associated with a subpacket configuration of two or more subpacket configurations, the subpacket configuration including a first code rate based on the subpacket including voice data, and the subpacket configuration including a second code rate based on the subpacket including the indication.

In some examples of the method, UEs, and non-transitory computer-readable medium described herein, the second code rate may be lower than the first code rate.

In some examples of the method, UEs, and non-transitory computer-readable medium described herein, receiving the one or more control messages may include operations, features, means, or instructions for receiving a single control message that activates a single radio resource control (RRC) configuration including both the uplink SPS configuration and the downlink SPS configuration.

In some examples of the method, UEs, and non-transitory computer-readable medium described herein, to receiving the one or more control messages may include operations, features, means, or instructions for receiving a first control message that activates a first RRC configuration indicating the uplink SPS configuration and receiving a second control message that activates a second RRC configuration indicating the downlink SPS configuration.

In some examples of the method, UEs, and non-transitory computer-readable medium described herein, to receiving the one or more control messages may include operations, features, means, or instructions for receiving a single control message that activates a first RRC configuration indicating the uplink SPS configuration and a second RRC configuration indicating the downlink SPS configuration.

Some examples of the method, UEs, and non-transitory computer-readable medium described herein may further include operations, features, means, or instructions for receiving an initial control message indicating a set of uplink SPS configurations and a set of downlink SPS configurations, where the one or more control messages include a first indication of the uplink SPS configuration of the set of uplink SPS configurations and a second indication of the downlink SPS configuration of the set of downlink SPS configurations.

In some examples of the method, UEs, and non-transitory computer-readable medium described herein, the downlink SPS configuration includes at least one of: a first SPS interval, a duration of a downlink resource of the set of multiple downlink resources, or a transmission time interval bundle size.

In some examples of the method, UEs, and non-transitory computer-readable medium described herein, the uplink SPS configuration includes at least one of: a second SPS interval, a duration of an uplink resource of the set of multiple uplink resources, or a transmission time interval bundle size.

In some examples of the method, UEs, and non-transitory computer-readable medium described herein, receiving the one or more downlink voice packets may include operations, features, means, or instructions for receiving, in accordance with the downlink SPS configuration, a downlink message for the UE including a third indication of one or more updated parameters for one or more downlink SPS configurations of the set of downlink SPS configurations or one or more uplink SPS configuration of the set of uplink SPS configurations, where receiving one or more subsequent downlink voice packets or transmitting one or more subsequent uplink voice packets may be based on the one or more updated parameters.

Some examples of the method, UEs, and non-transitory computer-readable medium described herein may further include operations, features, means, or instructions for transmitting assistance information associated with a reception of the one or more downlink voice packets or a transmission of the one or more uplink voice packets.

In some examples of the method, UEs, and non-transitory computer-readable medium described herein, transmitting the assistance information may include operations, features, means, or instructions for transmitting the assistance information via one or more uplink resources of the set of multiple uplink resources.

In some examples of the method, UEs, and non-transitory computer-readable medium described herein, receiving the one or more downlink voice packets may include operations, features, means, or instructions for receiving, in accordance with the downlink SPS configuration, a downlink voice packet including an indication of one or more updated parameters for the uplink SPS configuration or the downlink SPS configuration, where receiving one or more subsequent downlink voice packets or transmitting one or more subsequent uplink voice packets may be based on the one or more updated parameters.

In some examples of the method, UEs, and non-transitory computer-readable medium described herein, a MAC-CE includes the indication.

In some examples of the method, UEs, and non-transitory computer-readable medium described herein, the set of multiple downlink resources and the set of multiple uplink resources include a set of multiple time alternating downlink resources and uplink resources.

In some examples of the method, UEs, and non-transitory computer-readable medium described herein, transmitting the one or more uplink voice packets may include operations, features, means, or instructions for transmitting, in accordance with the uplink SPS configuration, an uplink message including an indication of a failure to decode a downlink voice packet of the one or more downlink voice packets.

Some examples of the method, UEs, and non-transitory computer-readable medium described herein may further include operations, features, means, or instructions for failing to decode a downlink voice packet of the one or more downlink voice packets, starting a timer associated with voice packet communication, where a duration of the timer may be based on failing to decode the downlink voice packet, and declaring a radio link failure (RLF) based on an expiration of the timer.

In some examples of the method, UEs, and non-transitory computer-readable medium described herein, refrain from monitoring a downlink control channel based on the uplink SPS configuration or the downlink SPS configuration being active.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports semi-persistent scheduling (SPS) for voice over non-terrestrial networks (NTN) in accordance with one or more aspects of the present disclosure.

FIG. 2 shows an example of a wireless communications system that supports SPS for voice over NTN in accordance with one or more aspects of the present disclosure.

FIG. 3 shows an example of a communications timeline that supports SPS for voice over NTN in accordance with one or more aspects of the present disclosure.

FIG. 4 shows an example of a process flow that supports SPS for voice over NTN in accordance with one or more aspects of the present disclosure.

FIGS. 5 and 6 show block diagrams of devices that support SPS for voice over NTN in accordance with one or more aspects of the present disclosure.

FIG. 7 shows a block diagram of a communications manager that supports SPS for voice over NTN in accordance with one or more aspects of the present disclosure.

FIG. 8 shows a diagram of a system including a device that supports SPS for voice over NTN in accordance with one or more aspects of the present disclosure.

FIGS. 9 through 11 show flowcharts illustrating methods that support SPS for voice over NTN in accordance with one or more aspects of the present disclosure.

### DETAILED DESCRIPTION

In some wireless communication systems, a user equipment (UE) may communicate voice traffic with a network entity in a non-terrestrial network (NTN). The NTN may be latency sensitive based on configuration of the network. The network entity may schedule downlink resource for downlink voice packets and uplink resources for uplink voice packets before each transmission. Scheduling each downlink voice packet and uplink voice packet may increase latency of the voice traffic and decrease communication efficiency in the NTN.

According to techniques described herein, the network entity may transmit one or more control message indicating (e.g., or activating) an uplink semi-persistent scheduling (SPS) configuration and a downlink SPS configuration. For example, the UE may receive control signaling including an indication of the uplink SPS configuration and the downlink SPS configuration, and the UE may activate the configuration after processing the control signaling. In some examples, the control signaling may activate the SPS configurations. The uplink SPS configuration and the downlink SPS configuration may allocate resources for voice traffic reducing the scheduling latency of the voice traffic. The UE may receive one or more downlink voice packets via downlink resource indicated by the downlink SPS configuration, and the UE may transmit one or more uplink voice packets via communication resources indicated by the uplink SPS configuration. For example, the UE and the network entity may communicate voice traffic via alternating uplink and downlink resources for voice traffic. The network entity may deactivate the uplink SPS configuration or the downlink SPS configuration via a downlink message. The downlink message may include an indication of a deactivation of the uplink SPS configuration or the downlink SPS configuration, and the UE may receive the downlink message in accordance with the downlink SPS configuration.

Aspects of the disclosure are initially described in the context of wireless communications systems. Additional aspects of the disclosure may be described in the context of a communications timeline and a process flow and said aspects may be deployed in many communication systems. Aspects of the disclosure are further illustrated by and described with reference to apparatus diagrams, system diagrams, and flowcharts that relate to SPS for voice over NTN.

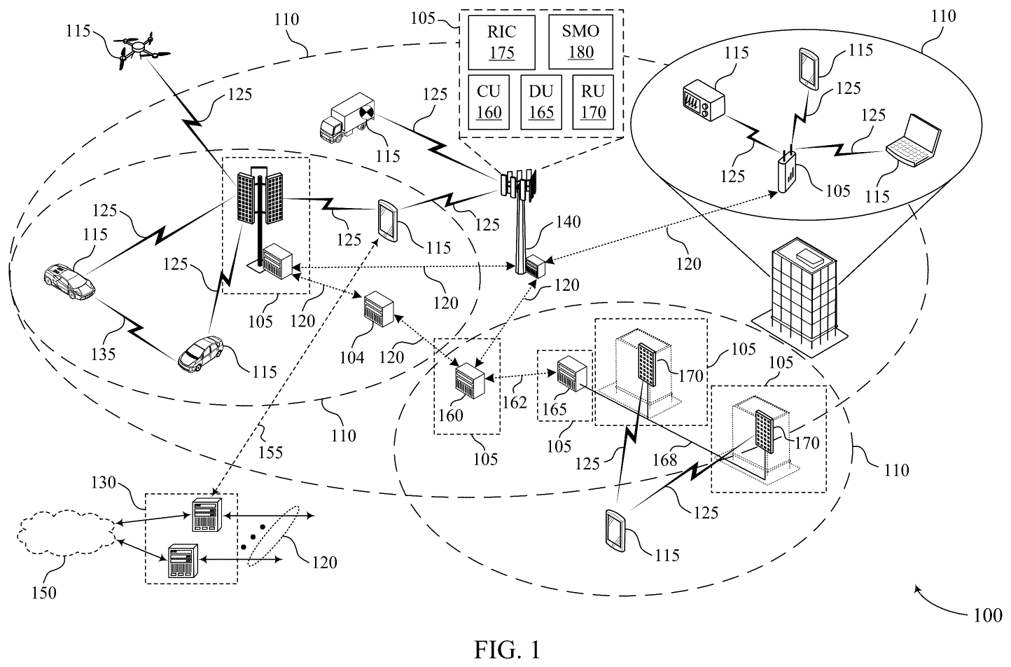

FIG. 1 shows an example of a wireless communications system 100 that supports SPS for voice over NTN in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, 6G Radio Interface (6GR), or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support SPS for voice over NTN as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, the network entity 105 may configure the UE 115 with an SPS configuration. For example, the UE 115-a (e.g., a NB-IoT device) may support an uplink SPS configuration (e.g., for buffer status reports (BSRs)). The SPS configuration (e.g., SR-SPS-BSR-Config-NB-r15) may include a cell radio network temporary identifier (C-RNTI) (e.g., semiPersistSchedC-RNTI) and a SPS interval (e.g., semiPersistSchedIntervalUL). The SPS interval may be 128 subframes, 256 subframes, 512 subframes, 1024 subframes, 1280 subframes, 2028 subframes, 2560 subframes, or 5120 subframes.

After a SPS uplink grant is configured, the MAC entity may set a subframe offset (e.g., Subframe_{offset}). In some examples (e.g., if a two interval configuration is enabled by an upper layer), the UE 115-a may set the subframe offset in accordance with a subframe table. In some examples (e.g., if a two interval configuration is disabled by an upper layer), the UE 115-a may set a subframe offset to zero. A grant in an SPS configuration may be calculated in accordance with Equation 1 and based on a system frame number (SFN)

$$( 10 * SFN + subframe ) = [ ( 10 * {SFN}_{StartTime} + {subframe}_{StartTime} ) + N * semiPersistSchedIntervalUL + {Subframe}_{offset} * ( N modulo 2 ] modulo 10240 \qquad ( 1 )$$

In Equation 1, an N^{th} grant may occurs in a transmission time interval (TTI) for which a subframe SPS is utilized. For the UEs 115 (e.g., NB-IoT UEs 115 or Bluetooth UEs 115) in enhanced coverage SFN_{StartTime} and subframe_{StartTime} may refer to a SFN and subframe of a first transmission of a physical uplink shared channel (PUSCH) where a configured uplink grant was initialized or reinitialized. For the NB-IoT UEs 115, a configured uplink grant may be used for transmitting BSRs or SPS confirmation transmissions. A skip uplink transmit SPS configuration (e.g., skipUplinkTxSPS) may be implicitly configured.

According to techniques described herein, the network entity 105 may transmit one or more control message activating an uplink SPS configuration and a downlink SPS configuration. The uplink SPS configuration and the downlink SPS configuration may allocate resources for voice traffic reducing the scheduling latency of the voice traffic. The UE 115 may receive one or more downlink voice packets via downlink resource indicated by the downlink SPS configuration, and the UE 115 may transmit one or more uplink voice packets via communication resources indicated by the uplink SPS configuration. For example, the UE 115 and the network entity 105 may communicate voice traffic via alternating uplink and downlink resources for voice traffic. The network entity may deactivate the uplink SPS configuration or the downlink SPS configuration via a downlink message. The downlink message may include an indication of a deactivation of the uplink SPS configuration or the downlink SPS configuration, and the UE 115 may receive the downlink message in accordance with the downlink SPS configuration.

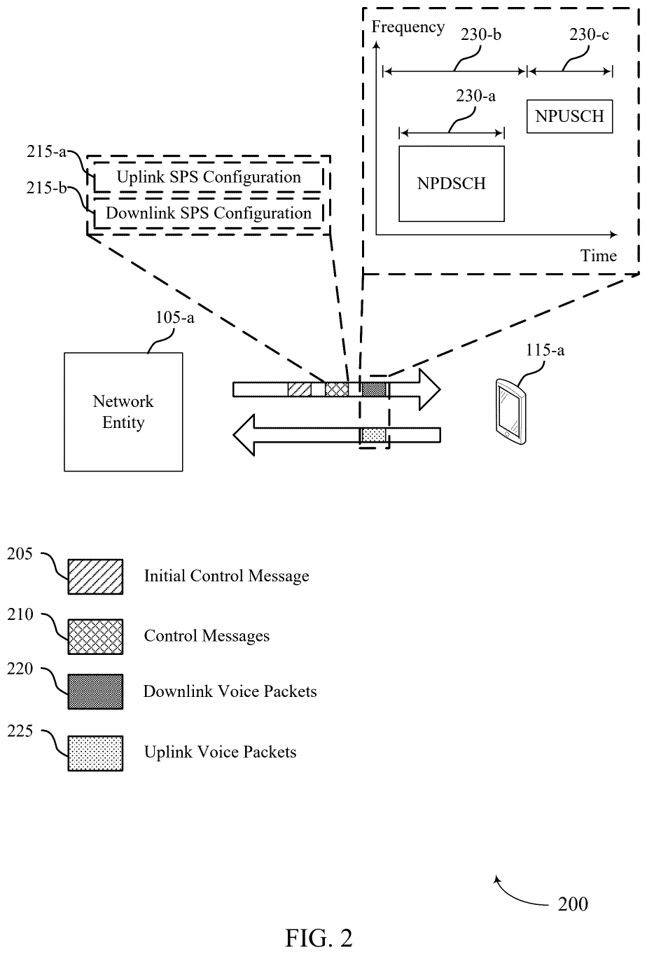

FIG. 2 shows an example of a wireless communications system 200 that supports SPS for voice over NTN in accordance with one or more aspects of the present disclosure. In some examples, wireless communications system 200 may implement aspects of wireless communications system 100. For example, a UE 115-a and a UE 115 b may represent an example of a UE, such as the UEs 115 described with reference to FIG. 1. A network entity 105-a and may represent an example of a network entity (e.g., a satellite in a NTN), such as the network entities 105 described with reference to FIG. 1. The UE 115-a may communicate with the network entity 105-a in a NTN. For example, the UE 115-a may transmit downlink voice packets 220, and the UE 115-a may receive uplink voice packets 225.

In some wireless communications systems, a network entity 105-a may transmit a first control message for a first duration (e.g., 2 millisecond (ms)) indicating first downlink communication resources (e.g., narrowband physical downlink shared channel (NPDSCH) via a downlink control channel. The first control message may be a downlink narrowband physical downlink control channel (NPDCCH) message. The network entity 105-a may transmit a second control message for a second duration (e.g., 2 ms) indicating uplink communication resources (e.g., narrowband PUSCH (NPUSCH)) via the downlink control channel. The second control message may be an uplink downlink narrowband physical downlink control channel (NPDCCH) message. The downlink control channel may include a first bandwidth (e.g., 180 kilohertz (kHz)) at a first sub-carrier spacing (SCS) (e.g., 15 kHz) during the first duration and the second duration.

The network entity 105-a may transmit a downlink voice packet via the downlink communication resources after a scheduling delay (e.g., 4 ms). The network entity 105-a may transmit the downlink voice packet to the UE 115-a for a downlink packet duration 230-a (e.g., 8 ms). Additionally, or alternatively, the UE 115-a may transmit an uplink voice packet after an additional delay (e.g., 4 ms). A cumulative duration 230-b (e.g., 16 ms) may include the scheduling delay, the third duration, and the additional delay.

The UE 115-a may transmit the uplink voice packet 225 for an uplink packet duration 230-c (e.g., 64 ms for 3 decibel (dB) relaxed margins or 128 ms for conservative margins) via an uplink shared uplink channel. The shared uplink channel may include a second bandwidth (e.g., 3.75 kHz) at a single tone during the uplink packet duration 230-c.

Scheduling each downlink voice packet and uplink voice packet may increase latency of voice traffic in the NTN and decrease communication efficiency in the NTN. For example, the first duration associated with the first control message, the second duration associated with the second control message, and the scheduling delay may increase latency of the voice traffic in the NTN.

According to techniques described herein, the network entity 105-a may transmit one or more control messages 210 activating an uplink SPS configuration 215-a, a downlink SPS configuration 215-b, or both. For example, the network entity 105-a may indicate an RRC configuration that activates an uplink SPS configuration 215-a or a downlink SPS configuration 215-b. The uplink SPS configuration 215-a and the downlink SPS configuration 215-b may allocate communication resources for voice traffic over the NTN reducing the scheduling latency of the data and/or voice traffic over the NTN. For example, the uplink SPS configuration 215-a and the downlink SPS configuration 215-b UE 115 may schedule voice traffic via alternating uplink resources and downlink resources. Alternative patterns can help mitigate latency associated with control overhead scenarios.

The network entity 105-a may configure one or more voice-specific SPS configuration (e.g., triggering both uplink and downlink) for the UE 115-a (e.g., via RRC signaling). For example, the uplink SPS configuration 215-a or the downlink SPS configuration 215-b may be defined by an associated RRC configuration. In some examples, one or more SPS configuration (e.g., the uplink SPS configuration 215-a, the downlink SPS configuration 215-b, or both) may be included in a single configuration (e.g., RRC configuration), for both uplink and downlink. For example, the network entity may configure a single SPS configuration via the one or more control messages 210. The single SPS configuration may include both the uplink SPS configuration 215-a and the downlink SPS configuration 215-b. In some examples, the network entity 105-a may configure separate (e.g., linked) configurations (e.g., RRC configuration) for the uplink SPS configuration 215-a and the downlink SPS configuration 215-b. The network entity 105-a may configure the uplink SPS configuration 215-a and the downlink SPS configuration 215-b via the one or more control messages 210. When indicated, activated or triggered, the one or more SPS configuration may indicate to the UE 115-a that both uplink and downlink are scheduled according to an uplink-downlink timeline.

In an illustrative example, the uplink-downlink timeline may configure the network entity 105-a to transmit signaling via a shared channel. For example, the network entity 105-a may transmit a downlink voice packet (e.g., a NPDSCH message) for a downlink packet duration 230-a (e.g., 8 ms) over a shared downlink channel and the UE 115-a to transmit an uplink voice packet (e.g., a NPUSCH message) for an uplink packet duration 230-c (e.g., 64 ms) over a shared uplink channel. The shared downlink channel may include one or more bandwidth parts (BWPs). In some examples, the downlink channel may include a first bandwidth (e.g., over 15 kHz) for the downlink packet duration 230-a, and the shared uplink channel may include a second bandwidth (e.g., over 3.75 kHz). In some cases, uplink-downlink timeline may include a switch gap (e.g., 1 ms) between the shared downlink channel and the shared uplink channel.

SPS signaling may have various aspects. In some examples, the activation or triggering for the one or more SPS configurations may be a single (e.g., common) control message 210 (e.g., a single downlink control information (DCI) or MAC-control element (MAC-CE)) for a single RRC configuration (e.g., common uplink and downlink SPS configuration). In some examples, the activation or triggering for the SPS configurations may be separate control messages 210 (e.g., separate DCI or MAC-CE) for separate or linked RRC configurations. In some examples, the activation or triggering for one or more SPS configurations may be a single (e.g., common) control message 210 (e.g., a single DCI or MAC-CE) for a separate (e.g., linked) RRC configuration (e.g., codepoints jointly indicating configurations from the uplink and downlink RRC configurations).

The network entity 105-a may transmit an initial control message 205. The initial control message 205 may indicate multiple candidate SPS configurations. The one or more control messages 210 may indicate which candidate SPS configuration is configured, indicated, or activated.

The network entity 105-a may indicate one or more candidate SPS configurations based on one or more link budgets or a voice codec-rates employed. The UE 115-a may determine the one or more link budgets based on narrowband reference signal (NRS) based measurements in downlink, and the UE 115-a may transmit an indication of the one or more link budgets to the network entity 105-a.

The one or more candidate SPS configurations of the multiple candidate SPS configurations may be negotiated or indicated. For example, the network entity 105-a may configure the UE 115-a for assistance information reporting. For example, assistance information reporting by the UE 115-a may be configured (e.g., specified) to facilitate a negotiation. For example, the network entity 105-a may indicate one or more candidate SPS configurations based on the assistance information.

The network entity 105-a may indicate one or more SPS configurations based on a codec rate. In other words, the network entity 105-a may perform a codec rate based determinations. For example, the network entity 105-a may transmit initial dynamically scheduled packets to determine a transport block size (TBSs).

The one or more SPS configuration may include multiple parameters. For example, the one or more SPS configuration may include an SPS interval (e.g., semiPersistSchedIntervalUL-DL), a parameter defining the downlink packet duration 230-a (e.g., a shared channel duration or an NPDSCH-duration), a parameter defining the third duration (e.g., NPUSCH-duration), or a TTI bundle size (e.g., TTI-bundlesize). The network entity 105-a may configure different values of the multiple parameters for the multiple candidate SPS configurations. For example, the network entity 105-a may configure, indicate, or activate different values of semiPersistSchedIntervalUL-DL, NPDSCH-duration, NPUSCH-duration, TTI-bundlesize (e.g., via a DCI or MAC-CE) from RRC-configured candidates (e.g., the multiple candidate SPS configurations).

The one or more SPS configurations (e.g., voice specific SPS configuration) may enable the network entity 105-a and the UE 115-a to communicate voice packets efficiently (e.g., in terms of resource-packing or capacity). For example, the voice traffic between the network entity 105-a and the UE 115-a may be a relatively dense configuration in time (e.g., a relatively higher content of voice traffic per time period). For example, the one or more SPS configurations may enable a quantity (N) of uplink-downlink 80 ms TTIs back-to-back. The UE 115-a may be unable to monitor for NPDCCH (e.g., a deactivation DCI) when the one or more SPS configurations for voice state are active. In some examples, the UE 115-a may not monitor for NPDCCH when an SPS configuration for voice state is active.

The network entity 105-a may transmit a deactivation MAC-CE message via downlink communication resources scheduled by the one or more SPS configurations. For example, one or more SPS configurations (e.g., SPS for voice) may be deactivated via a MAC-CE message. The deactivation MAC-CE may be conveyed in a shared channel such as an NPDSCH scheduled as part of the one or more SPS configurations.

The network entity 105-a may transmit an indication of an update to the one or more candidate SPS configurations of the multiple candidate SPS configurations. For example, the network entity 105-a may transmit a MAC-CE (e.g., similar to the deactivation MAC-CE) to modify a subset of parameters for the uplink SPS configuration 215-a or the downlink SPS configuration 215-b (e.g., SPS for voice configuration). For example, the network entity 105-a may determine that one or more link budgets have worsened or improved for uplink. The network entity 105-a may update the subset of parameters for the uplink SPS configuration 215-a or the downlink SPS configuration 215-b based on the one or more link budgets.

The network entity 105-a may adjust the network resources (e.g., the uplink communication resource scheduled by the uplink SPS configuration 215-a or the downlink communication resources schedule by the downlink SPS configuration 215-b). The network entity 105-a may adjust the network resources based on a quantity of UEs 115 served by the network entity 105-a, reliability and capacity tradeoffs, or changes in voice codec rates, etc.

The network entity 105-a may transmit a MAC-CE to update or modify the one or more SPS configurations. The MAC-CE may indicate a code point of multiple codepoints (e.g., corresponding to one or more candidate SPS configurations). In some examples, the codepoints may be common across a single SPS configuration (e.g., an uplink and downlink SPS configuration). In some examples, the codepoints may be separate codepoints for the uplink SPS configuration 215-a and the downlink SPS configurations 215-b.

A UE may be configured to improve efficiency. For example, if a shared channel message such as an NPDSCH message (e.g., a NPDSCH message containing the deactivating MAC-CE) is not decoded by the UE 115-a, the UE 115-a may be configured to minimize resource wastage or wasteful UE monitoring. In some examples, the UE 115-a may declare radio link failure (RLF) after expiration of a RLF timer. An RLF cause or the RLF timer values may be specific to SPS for voice. In some examples, the UE 115-a may report to the network entity 105-a, via an uplink resource scheduled as part of the uplink SPS configuration 215-a, that shared channel decoding (e.g., NPDSCH decoding) failed.

The UE 115-a may be configured to blind decode two or more shared channel resources such as NPDSCH resources (e.g., associated with two or more subpacket configurations). For example, the UE 115-a may blind decode a first NPDSCH resource in accordance with an SPS for voice TBS, and the UE 115-a may blind decode a second NPDSCH resource for a deactivation MAC-CE. The deactivation MAC-CE may have a lower code rate and better coverage based on the lower code rate. A first subpacket configuration associated with the first MPDSCH resource may include a first code rate based on the subpacket including voice data. A second subpacket configuration associated with the second NPDSCH resource may include a second code rate based on the subpacket including the indication.

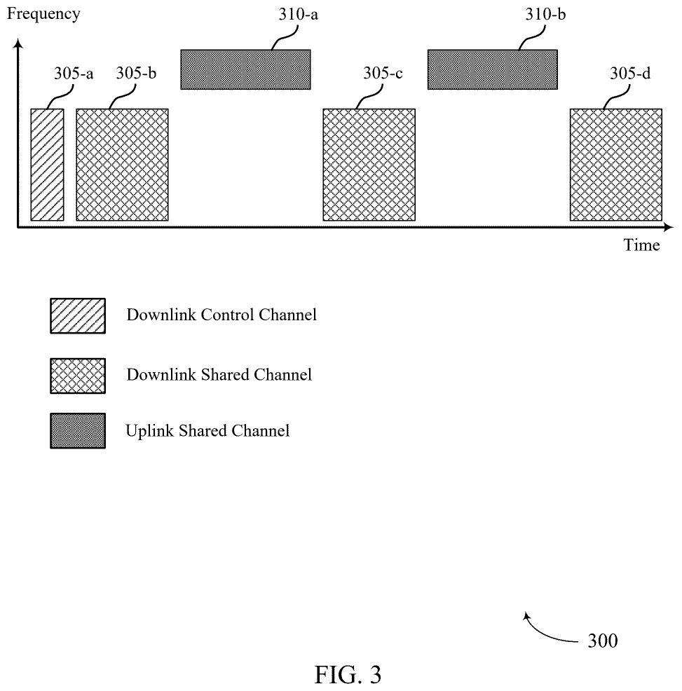

FIG. 3 shows an example of a communications timeline 300 that supports SPS for voice over NTN in accordance with one or more aspects of the present disclosure. A UE 115 and a network entity 105 may communicate in accordance with the communications timeline 300. For example, the network entity 105-a may transmit an uplink SPS configuration and a downlink SPS configuration via downlink communication resources 305-a. The uplink SPS configuration and the downlink SPS configuration may be included in the same SPS configuration. The downlink SPS configuration may schedule periodic downlink communications resources 305 (e.g., the downlink communication resources 305-a and the downlink communication resources 305-b). The uplink SPS configuration may schedule periodic uplink communication resources 310 (e.g., the uplink communication resources 310-a and the uplink communication resources 310-b).

The network entity 105 may transmit a first downlink voice packet via the downlink communication resources 305-b. The UE 115-a may transmit a first uplink voice packet via uplink communication resources 310-a. In some cases, the network entity 105 may refrain from transmitting via the downlink communication resources 305-c based on a quantity of downlink voice traffic. The UE 115-a may transmit a second uplink voice packet via the uplink communication resources 310-b. The network entity may transmit a deactivation MAC-CE via the downlink communication resources 305-d. The UE 115-a may deactivate the uplink SPS configuration, the downlink SPS configuration, or both based on the deactivation MAC-CE.

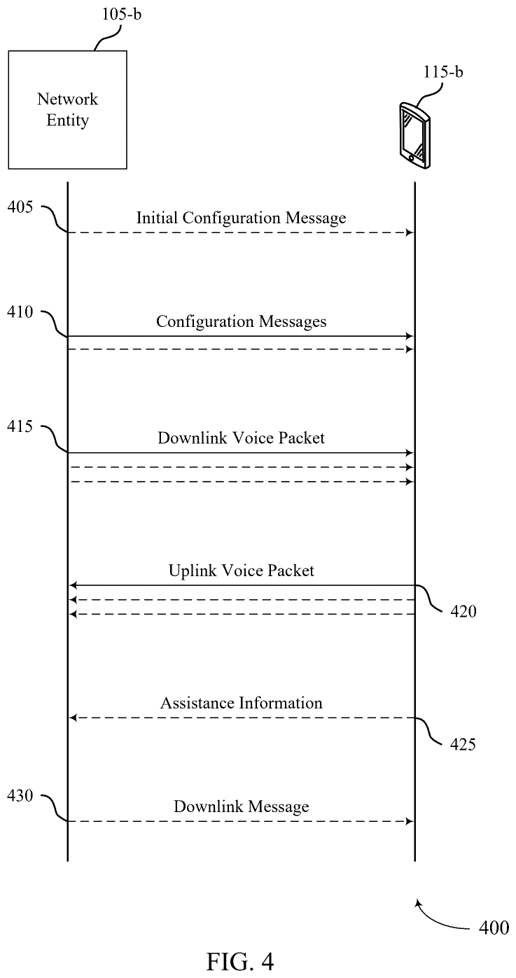

FIG. 4 shows an example of a process flow 400 that supports SPS for voice over NTN in accordance with one or more aspects of the present disclosure. In some examples, process flow 400 may implement aspects of, or be implemented by aspects of, the wireless communications system 100, the wireless communications system 200, or the communications timeline 300. For example, the process flow 400 may include a UE 115-b and a network entity 105-b which may be examples of corresponding devices described with reference to FIGS. 1-3. The network entity 105-b and the UE 115-b may communicate voice traffic in a NTN.

At 405, the UE 115-b may receive an initial control message indicating a set of uplink SPS configurations and a set of downlink SPS configurations. The one or more control messages may include a first indication of the uplink SPS configuration of the set of uplink SPS configurations and a second indication of the downlink SPS configuration of the set of downlink SPS configurations. In some cases, the downlink SPS configuration may include at least one of: a first SPS interval, a duration of a downlink resource of the set of downlink resources, or a transmission time interval bundle size. The uplink SPS configuration may include at least one of: a second SPS interval, a duration of an uplink resource of the set of uplink resources, or the transmission time interval bundle size.

In some cases, the UE 115-b may receive, in accordance with the downlink SPS configuration, a downlink message for the UE 115-b including a third indication of one or more updated parameters for one or more downlink SPS configurations of the set of downlink SPS configurations or one or more uplink SPS configuration of the set of uplink SPS configurations. Receiving one or more subsequent downlink voice packets or transmitting one or more subsequent uplink voice packets may be based on the one or more updated parameters

At 410, the UE 115-b may receive one or more control messages that indicates or activate both an SPS configuration for voice traffic for the UE 115-b and a downlink SPS configuration for the voice traffic for the UE 115-b. For example, the control message may indicate an SPS configuration and a downlink SPS configuration, and decoding the control signaling may result in the UE 115-b entering a communication mode (e.g., activating an SPS configuration for voice traffic or data for the UE 115-b and a downlink SPS configuration for the data or voice traffic for the UE 115-b). In some cases, the UE 115-b may receive a single control message that indicates or activates a single RRC configuration including both the uplink SPS configuration and the downlink SPS configuration. In some cases, the UE 115-b may receive a single control message that indicates or activates a first RRC configuration indicating the uplink SPS configuration and a second RRC configuration indicating the downlink SPS configuration.

In some cases, the UE 115-b may receive a first control message that indicates or activates a first RRC configuration indicating the uplink SPS configuration. The UE 115-b may receive a second control message that indicates or activates a second RRC configuration indicating the downlink SPS configuration. In some cases, the UE 115-b may refrain from monitoring a downlink control channel (e.g., NPDCCH) based on the uplink SPS configuration or the downlink SPS configuration being active

At 415, the UE 115-b may receive, in accordance with the downlink SPS configuration, one or more downlink voice packets for the UE 115-b via first downlink resources of a set of downlink resources indicated by the downlink SPS configuration indicates or activated by the one or more control messages. The set of downlink resources and the set of uplink resources may include a set of time alternating downlink resources and uplink resources.

In some cases, the UE 115-b may receive, in accordance with the downlink SPS configuration, a downlink voice packet including an indication of one or more updated parameters for the uplink SPS configuration or the downlink SPS configuration. Receiving one or more subsequent downlink voice packets or transmitting one or more subsequent uplink voice packets may be based on the one or more updated parameters. A MAC-CE may include the indication.

In some cases, the UE 115-b may transmit, in accordance with the uplink SPS configuration, an uplink message including an indication of a failure to decode a downlink voice packet of the one or more downlink voice packets. For example, the UE 115-b may fail to decode a downlink voice packet of the one or more downlink voice packets. The UE 115-b may start a timer associated with voice packet communication, wherein a duration of the timer is based on failing to decode the downlink voice packet. The UE 115-b may declare a RLF based on an expiration of the timer.

At 420, the UE 115-b may transmit, in accordance with the uplink SPS configuration, one or more uplink voice packets for the UE 115-b via first uplink resources of a set of uplink resources indicated by the uplink SPS configuration indicates or activated by the one or more control messages. The UE 115-b may alternate between transmitting an uplink voice packet of the one or more uplink voice packets and receiving a downlink voice packet of the one or more downlink voice packets in a same time window, as described with reference to FIG. 3.

At 425, the UE 115-b may transmitting assistance information associated with a reception of the one or more downlink voice packets or a transmission of the one or more uplink voice packets. In some cases, the UE 115-b may transmit the assistance information via one or more uplink resources of the set of uplink resources.

At 430, the UE 115-b may receive, in accordance with the downlink SPS configuration, a downlink message (e.g., a MAC-CE message as described with reference to FIG. 2) including an indication of a deactivation of at least one of the uplink SPS configuration or the downlink SPS configuration. In some cases, a MAC-CE may include the indication.

The downlink message may include a subpacket associated with a subpacket configuration of two or more subpacket configurations. The subpacket configuration may include a first code rate based on the subpacket including voice data, or the subpacket configuration may include a second code rate based on the subpacket including the indication. In some cases, the second code rate may be lower than the first code rate.

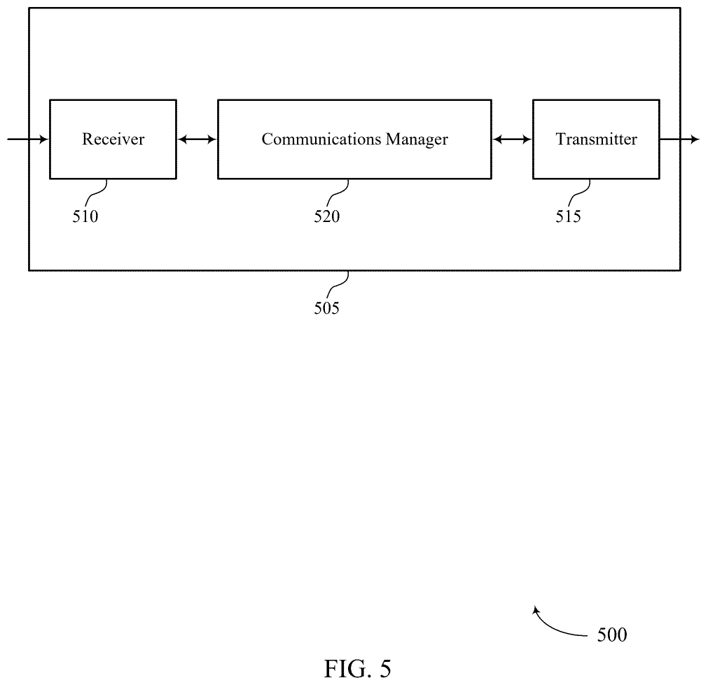

FIG. 5 shows a block diagram 500 of a device 505 that supports SPS for voice over NTN in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to SPS for voice over NTN). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SPS for voice over NTN). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of SPS for voice over NTN as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving one or more control messages that indicates or activate both an uplink SPS configuration for voice traffic for the UE and a downlink SPS configuration for the voice traffic for the UE. The communications manager 520 is capable of, configured to, or operable to support a means for receiving, in accordance with the downlink SPS configuration, one or more downlink voice packets for the UE via first downlink resources of a set of multiple downlink resources indicated by the downlink SPS configuration indicated or activated by the one or more control messages. The communications manager 520 is capable of, configured to, or operable to support a means for transmitting, in accordance with the uplink SPS configuration, one or more uplink voice packets for the UE via first uplink resources of a set of multiple uplink resources indicated by the uplink SPS configuration indicated or activated by the one or more control messages.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources and the like.

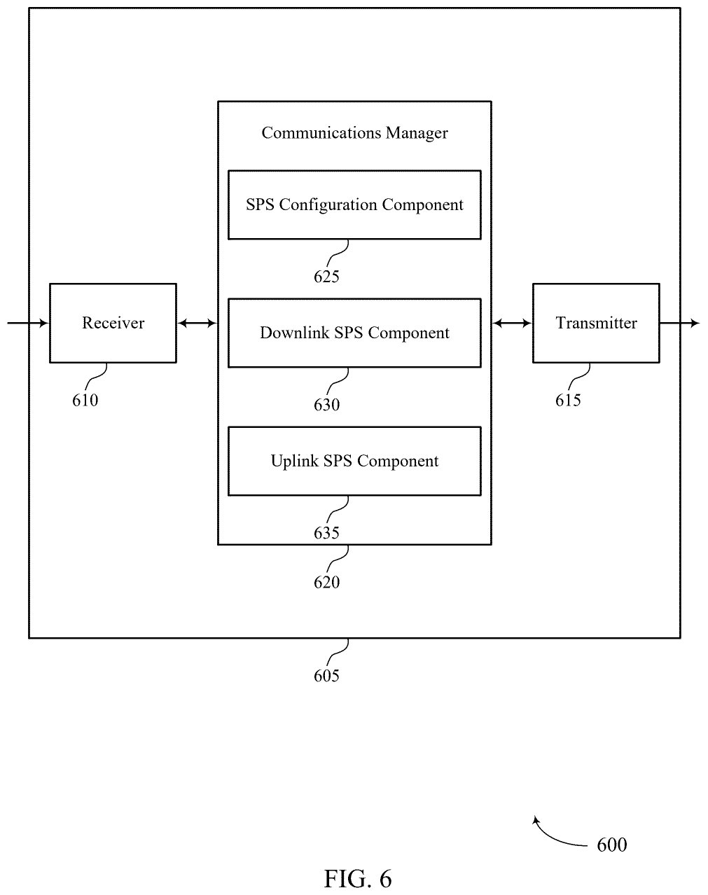

FIG. 6 shows a block diagram 600 of a device 605 that supports SPS for voice over NTN in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to SPS for voice over NTN). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SPS for voice over NTN). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SPS for voice over NTN as described herein. For example, the communications manager 620 may include an SPS configuration component 625, a downlink SPS component 630, an uplink SPS component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The SPS configuration component 625 is capable of, configured to, or operable to support a means for receiving one or more control messages that indicate or activate both an uplink SPS configuration for voice traffic for the UE and a downlink SPS configuration for the voice traffic for the UE. The downlink SPS component 630 is capable of, configured to, or operable to support a means for receiving, in accordance with the downlink SPS configuration, one or more downlink voice packets for the UE via first downlink resources of a set of multiple downlink resources indicated by the downlink SPS configuration indicated or activated by the one or more control messages. The uplink SPS component 635 is capable of, configured to, or operable to support a means for transmitting, in accordance with the uplink SPS configuration, one or more uplink voice packets for the UE via first uplink resources of a set of multiple uplink resources indicated by the uplink SPS configuration indicated or activated by the one or more control messages.

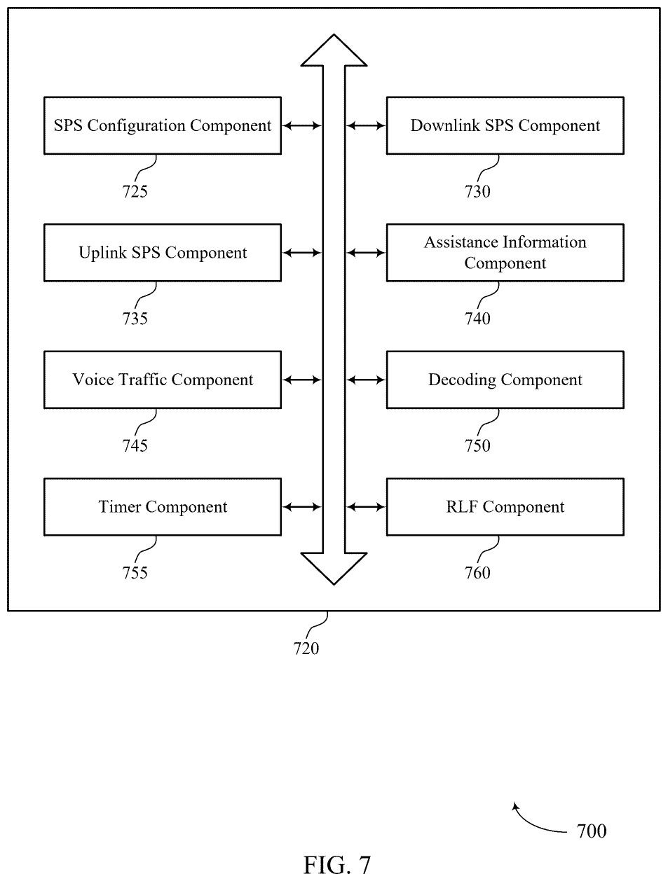

FIG. 7 shows a block diagram 700 of a communications manager 720 that supports SPS for voice over NTN in accordance with one or more aspects of the present disclosure. The communications manager 720 may be an example of aspects of a communications manager 520, a communications manager 620, or both, as described herein. The communications manager 720, or various components thereof, may be an example of means for performing various aspects of SPS for voice over NTN as described herein. For example, the communications manager 720 may include an SPS configuration component 725, a downlink SPS component 730, an uplink SPS component 735, an assistance information component 740, a voice traffic component 745, a decoding component 750, a timer component 755, an RLF component 760, or any combination thereof. Each of these components, or components or subcomponents thereof (e.g., one or more processors, one or more memories), may communicate, directly or indirectly, with one another (e.g., via one or more buses).

The communications manager 720 may support wireless communication in accordance with examples as disclosed herein. The SPS configuration component 725 is capable of, configured to, or operable to support a means for receiving one or more control messages that indicate or activate both an uplink SPS configuration for voice traffic for the UE and a downlink SPS configuration for the voice traffic for the UE. The downlink SPS component 730 is capable of, configured to, or operable to support a means for receiving, in accordance with the downlink SPS configuration, one or more downlink voice packets for the UE via first downlink resources of a set of multiple downlink resources indicated by the downlink SPS configuration indicated or activated by the one or more control messages. The uplink SPS component 735 is capable of, configured to, or operable to support a means for transmitting, in accordance with the uplink SPS configuration, one or more uplink voice packets for the UE via first uplink resources of a set of multiple uplink resources indicated by the uplink SPS configuration indicated or activated by the one or more control messages.

In some examples, to support receiving the one or more downlink voice packets, the SPS configuration component 725 is capable of, configured to, or operable to support a means for receiving, in accordance with the downlink SPS configuration, a downlink message including an indication of a deactivation of at least one of the uplink SPS configuration or the downlink SPS configuration. In some examples, a MAC-CE includes the indication.

In some examples, the downlink message includes a subpacket associated with a subpacket configuration of two or more subpacket configurations, the subpacket configuration including a first code rate based on the subpacket including voice data, and the subpacket configuration including a second code rate based on the subpacket including the indication. In some examples, the second code rate is lower than the first code rate.

In some examples, to support receiving the one or more control messages, the SPS configuration component 725 is capable of, configured to, or operable to support a means for receiving a single control message that indicates or activates a single RRC configuration including both the uplink SPS configuration and the downlink SPS configuration.

In some examples, to support receiving the one or more control messages, the SPS configuration component 725 is capable of, configured to, or operable to support a means for receiving a first control message that indicates or activates a first RRC configuration indicating the uplink SPS configuration. In some examples, to support receiving the one or more control messages, the SPS configuration component 725 is capable of, configured to, or operable to support a means for receiving a second control message that indicates or activates a second RRC configuration indicating the downlink SPS configuration.

In some examples, to support receiving the one or more control messages, the SPS configuration component 725 is capable of, configured to, or operable to support a means for receiving a single control message that indicates or activates a first RRC configuration indicating the uplink SPS configuration and a second RRC configuration indicating the downlink SPS configuration.

In some examples, the SPS configuration component 725 is capable of, configured to, or operable to support a means for receiving an initial control message indicating a set of uplink SPS configurations and a set of downlink SPS configurations, where the one or more control messages include a first indication of the uplink SPS configuration of the set of uplink SPS configurations and a second indication of the downlink SPS configuration of the set of downlink SPS configurations.

In some examples, the downlink SPS configuration includes at least one of: a first SPS interval, a duration of a downlink resource of the set of multiple downlink resources, or a transmission time interval bundle size.

In some examples, the uplink SPS configuration includes at least one of: a second SPS interval, a duration of an uplink resource of the set of multiple uplink resources, or a transmission time interval bundle size.

In some examples, to support receiving the one or more downlink voice packets, the SPS configuration component 725 is capable of, configured to, or operable to support a means for receiving, in accordance with the downlink SPS configuration, a downlink message for the UE including a third indication of one or more updated parameters for one or more downlink SPS configurations of the set of downlink SPS configurations or one or more uplink SPS configuration of the set of uplink SPS configurations, where receiving one or more subsequent downlink voice packets or transmitting one or more subsequent uplink voice packets is based on the one or more updated parameters.

In some examples, the assistance information component 740 is capable of, configured to, or operable to support a means for transmitting assistance information associated with a reception of the one or more downlink voice packets or a transmission of the one or more uplink voice packets.

In some examples, to support transmitting the assistance information, the assistance information component 740 is capable of, configured to, or operable to support a means for transmitting the assistance information via one or more uplink resources of the set of multiple uplink resources.

In some examples, to support receiving the one or more downlink voice packets, the voice traffic component 745 is capable of, configured to, or operable to support a means for receiving, in accordance with the downlink SPS configuration, a downlink voice packet including an indication of one or more updated parameters for the uplink SPS configuration or the downlink SPS configuration, where receiving one or more subsequent downlink voice packets or transmitting one or more subsequent uplink voice packets is based on the one or more updated parameters. In some examples, a MAC-CE includes the indication.

In some examples, the set of multiple downlink resources and the set of multiple uplink resources include a set of multiple time alternating downlink resources and uplink resources.

In some examples, to support transmitting the one or more uplink voice packets, the decoding component 750 is capable of, configured to, or operable to support a means for transmitting, in accordance with the uplink SPS configuration, an uplink message including an indication of a failure to decode a downlink voice packet of the one or more downlink voice packets.

In some examples, the decoding component 750 is capable of, configured to, or operable to support a means for failing to decode a downlink voice packet of the one or more downlink voice packets. In some examples, the timer component 755 is capable of, configured to, or operable to support a means for starting a timer associated with voice packet communication, where a duration of the timer is based on failing to decode the downlink voice packet. In some examples, the RLF component 760 is capable of, configured to, or operable to support a means for declaring a radio link failure based on an expiration of the timer.

In some examples, the SPS configuration component 725 is capable of, configured to, or operable to support a means for refraining from monitoring a downlink control channel based on the uplink SPS configuration or the downlink SPS configuration being active.

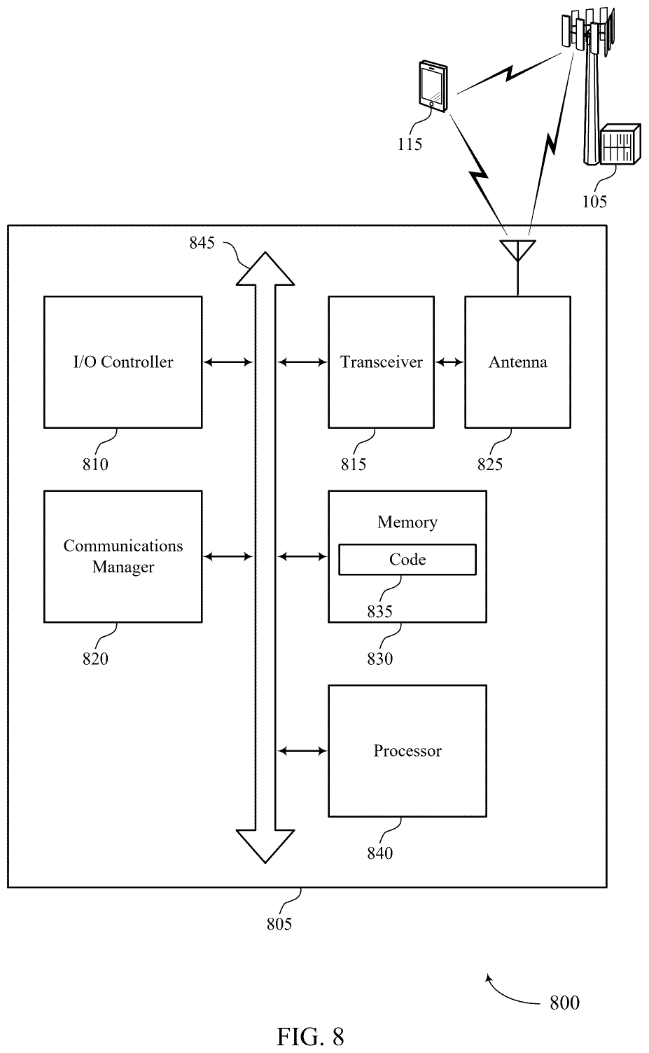

FIG. 8 shows a diagram of a system 800 including a device 805 that supports SPS for voice over NTN in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting SPS for voice over NTN). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication in accordance with examples as disclosed herein. For example, the communications manager 820 is capable of, configured to, or operable to support a means for receiving one or more control messages that indicate or activate both an uplink SPS configuration for voice traffic for the UE and a downlink SPS configuration for the voice traffic for the UE. The communications manager 820 is capable of, configured to, or operable to support a means for receiving, in accordance with the downlink SPS configuration, one or more downlink voice packets for the UE via first downlink resources of a set of multiple downlink resources indicated by the downlink SPS configuration indicated or activated by the one or more control messages. The communications manager 820 is capable of, configured to, or operable to support a means for transmitting, in accordance with the uplink SPS configuration, one or more uplink voice packets for the UE via first uplink resources of a set of multiple uplink resources indicated by the uplink SPS configuration indicated or activated by the one or more control messages.

By including or configuring the communications manager 820 in accordance with examples as described herein, the device 805 may support techniques for reduced latency, more efficient utilization of communication resources, improved coordination between devices, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of SPS for voice over NTN as described herein, or the at least one processor 840 and the at least one memory 830 may be otherwise configured to, individually or collectively, perform or support such operations.

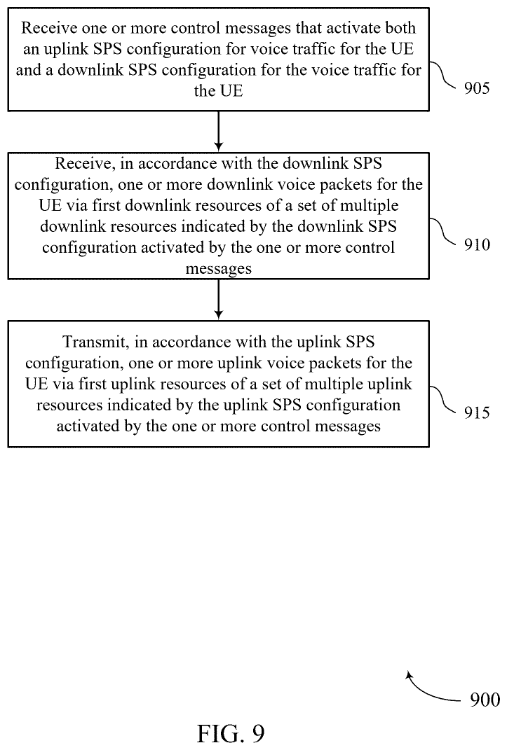

FIG. 9 shows a flowchart illustrating a method 900 that supports SPS for voice over NTN in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving one or more control messages that indicate or activate both an uplink SPS configuration for voice traffic for the UE and a downlink SPS configuration for the voice traffic for the UE. The operations of 905 may be performed in accordance with examples as disclosed herein. In some examples, aspects of the operations of 905 may be performed by an SPS configuration component 725 as described with reference to FIG. 7.

At 910, the method may include receiving, in accordance with the downlink SPS configuration, one or more downlink voice packets for the UE via first downlink resources of a set of multiple downlink resources indicated by the downlink SPS configuration indicated or activated by the one or more control messages. The operations of 910 may be performed in accordance with examples as disclosed herein. In some examples, aspects of the operations of 910 may be performed by a downlink SPS component 730 as described with reference to FIG. 7.

At 915, the method may include transmitting, in accordance with the uplink SPS configuration, one or more uplink voice packets for the UE via first uplink resources of a set of multiple uplink resources indicated by the uplink SPS configuration indicated or activated by the one or more control messages. The operations of 915 may be performed in accordance with examples as disclosed herein. In some examples, aspects of the operations of 915 may be performed by an uplink SPS component 735 as described with reference to FIG. 7.

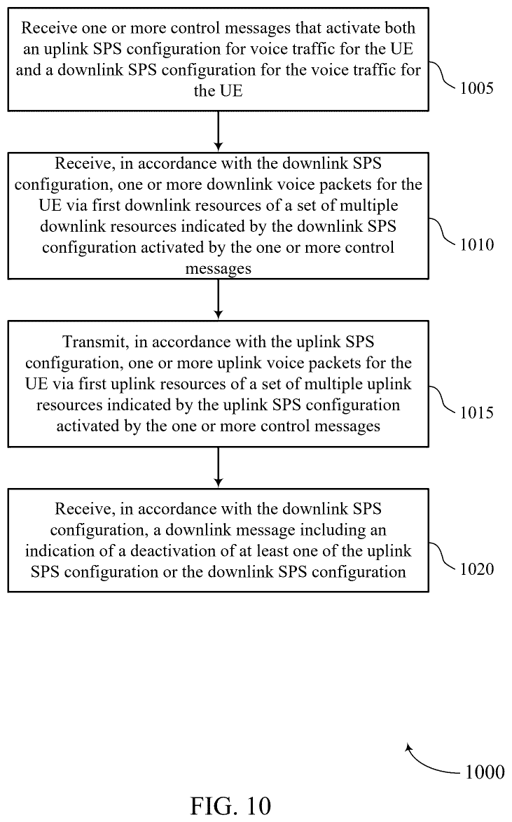

FIG. 10 shows a flowchart illustrating a method 1000 that supports SPS for voice over NTN in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving one or more control messages that indicate or activate both an uplink SPS configuration for voice traffic for the UE and a downlink SPS configuration for the voice traffic for the UE. The operations of 1005 may be performed in accordance with examples as disclosed herein. In some examples, aspects of the operations of 1005 may be performed by an SPS configuration component 725 as described with reference to FIG. 7.

At 1010, the method may include receiving, in accordance with the downlink SPS configuration, one or more downlink voice packets for the UE via first downlink resources of a set of multiple downlink resources indicated by the downlink SPS configuration indicated or activated by the one or more control messages. The operations of 1010 may be performed in accordance with examples as disclosed herein. In some examples, aspects of the operations of 1010 may be performed by a downlink SPS component 730 as described with reference to FIG. 7.

At 1015, the method may include transmitting, in accordance with the uplink SPS configuration, one or more uplink voice packets for the UE via first uplink resources of a set of multiple uplink resources indicated by the uplink SPS configuration indicated or activated by the one or more control messages. The operations of 1015 may be performed in accordance with examples as disclosed herein. In some examples, aspects of the operations of 1015 may be performed by an uplink SPS component 735 as described with reference to FIG. 7.

At 1020, the method may include receiving, in accordance with the downlink SPS configuration, a downlink message including an indication of a deactivation of at least one of the uplink SPS configuration or the downlink SPS configuration. The operations of 1020 may be performed in accordance with examples as disclosed herein. In some examples, aspects of the operations of 1020 may be performed by an SPS configuration component 725 as described with reference to FIG. 7.

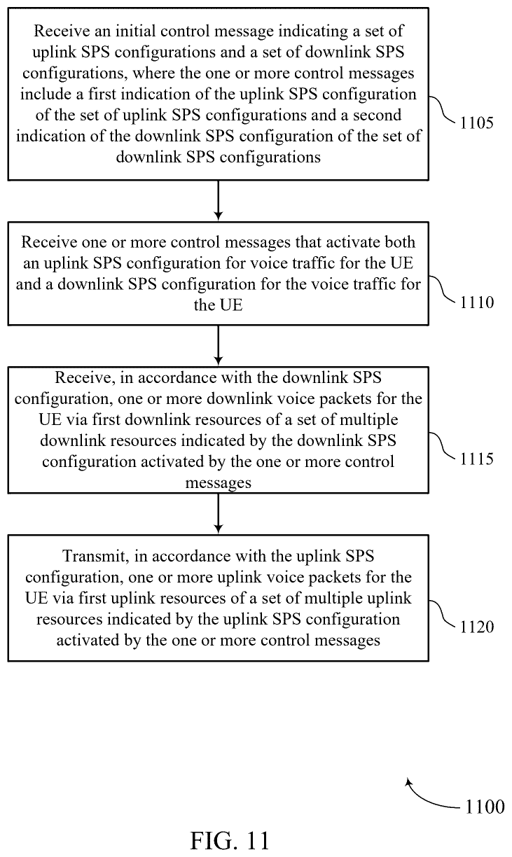

FIG. 11 shows a flowchart illustrating a method 1100 that supports SPS for voice over NTN in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving an initial control message indicating a set of uplink SPS configurations and a set of downlink SPS configurations, where the one or more control messages include a first indication of the uplink SPS configuration of the set of uplink SPS configurations and a second indication of the downlink SPS configuration of the set of downlink SPS configurations. The operations of 1105 may be performed in accordance with examples as disclosed herein. In some examples, aspects of the operations of 1105 may be performed by an SPS configuration component 725 as described with reference to FIG. 7.

At 1110, the method may include receiving one or more control messages that indicate or activate both an uplink SPS configuration for voice traffic for the UE and a downlink SPS configuration for the voice traffic for the UE. The operations of 1110 may be performed in accordance with examples as disclosed herein. In some examples, aspects of the operations of 1110 may be performed by an SPS configuration component 725 as described with reference to FIG. 7.

At 1115, the method may include receiving, in accordance with the downlink SPS configuration, one or more downlink voice packets for the UE via first downlink resources of a set of multiple downlink resources indicated by the downlink SPS configuration indicated or activated by the one or more control messages. The operations of 1115 may be performed in accordance with examples as disclosed herein. In some examples, aspects of the operations of 1115 may be performed by a downlink SPS component 730 as described with reference to FIG. 7.

At 1120, the method may include transmitting, in accordance with the uplink SPS configuration, one or more uplink voice packets for the UE via first uplink resources of a set of multiple uplink resources indicated by the uplink SPS configuration indicated or activated by the one or more control messages. The operations of 1120 may be performed in accordance with examples as disclosed herein. In some examples, aspects of the operations of 1120 may be performed by an uplink SPS component 735 as described with reference to FIG. 7.

The following provides an overview of aspects of the present disclosure:

Aspect 1: A method for wireless communication at a UE, comprising: receiving one or more control messages that indicate or activate both an uplink SPS configuration for voice traffic for the UE and a downlink SPS configuration for the voice traffic for the UE; receiving, in accordance with the downlink SPS configuration, one or more downlink voice packets for the UE via first downlink resources of a plurality of downlink resources indicated by the downlink SPS configuration indicated or activated by the one or more control messages; and transmitting, in accordance with the uplink SPS configuration, one or more uplink voice packets for the UE via first uplink resources of a plurality of uplink resources indicated by the uplink SPS configuration indicated or activated by the one or more control messages.

Aspect 2: The method of aspect 1, wherein receiving the one or more downlink voice packets comprises: receiving, in accordance with the downlink SPS configuration, a downlink message comprising an indication of a deactivation of at least one of the uplink SPS configuration or the downlink SPS configuration.

Aspect 3: The method of aspect 2, wherein a MAC-CE comprises the indication.

Aspect 4: The method of any of aspects 2 through 3, wherein the downlink message comprises a subpacket associated with a subpacket configuration of two or more subpacket configurations, the subpacket configuration comprising a first code rate based at least in part on the subpacket comprising voice data, and the subpacket configuration comprising a second code rate based at least in part on the subpacket comprising the indication.

Aspect 5: The method of aspect 4, wherein the second code rate is lower than the first code rate.

Aspect 6: The method of any of aspects 1 through 5, wherein receiving the one or more control messages comprises: receiving a single control message that indicates or activates a single RRC configuration comprising both the uplink SPS configuration and the downlink SPS configuration.

Aspect 7: The method of any of aspects 1 through 5, wherein to receiving the one or more control messages further comprises: receiving a first control message that indicates or activates a first RRC configuration indicating the uplink SPS configuration; and receiving a second control message that indicates or activates a second RRC configuration indicating the downlink SPS configuration.

Aspect 8: The method of any of aspects 1 through 5, wherein to receiving the one or more control messages further comprises: receiving a single control message that indicates or activates a first RRC configuration indicating the uplink SPS configuration and a second RRC configuration indicating the downlink SPS configuration.

Aspect 9: The method of any of aspects 1 through 8, further comprising: receiving an initial control message indicating a set of uplink SPS configurations and a set of downlink SPS configurations, wherein the one or more control messages comprise a first indication of the uplink SPS configuration of the set of uplink SPS configurations and a second indication of the downlink SPS configuration of the set of downlink SPS configurations.

Aspect 10: The method of aspect 9, wherein the downlink SPS configuration comprises at least one of: a first SPS interval, a duration of a downlink resource of the plurality of downlink resources, or a transmission time interval bundle size.

Aspect 11: The method of any of aspects 9 through 10, wherein the uplink SPS configuration comprises at least one of: a second SPS interval, a duration of an uplink resource of the plurality of uplink resources, or a transmission time interval bundle size.

Aspect 12: The method of any of aspects 9 through 11, wherein receiving the one or more downlink voice packets comprises: receiving, in accordance with the downlink SPS configuration, a downlink message for the UE comprising a third indication of one or more updated parameters for one or more downlink SPS configurations of the set of downlink SPS configurations or one or more uplink SPS configuration of the set of uplink SPS configurations, wherein receiving one or more subsequent downlink voice packets or transmitting one or more subsequent uplink voice packets is based at least in part on the one or more updated parameters.

Aspect 13: The method of any of aspects 1 through 12, further comprising: transmitting assistance information associated with a reception of the one or more downlink voice packets or a transmission of the one or more uplink voice packets.

Aspect 14: The method of aspect 13, wherein transmitting the assistance information comprises: transmitting the assistance information via one or more uplink resources of the plurality of uplink resources.

Aspect 15: The method of any of aspects 1 through 14, wherein receiving the one or more downlink voice packets comprises: receiving, in accordance with the downlink SPS configuration, a downlink voice packet comprising an indication of one or more updated parameters for the uplink SPS configuration or the downlink SPS configuration, wherein receiving one or more subsequent downlink voice packets or transmitting one or more subsequent uplink voice packets is based at least in part on the one or more updated parameters.

Aspect 16: The method of aspect 15, wherein a MAC-CE comprises the indication.

Aspect 17: The method of any of aspects 1 through 16, wherein the plurality of downlink resources and the plurality of uplink resources comprise a plurality of time alternating downlink resources and uplink resources.

Aspect 18: The method of any of aspects 1 through 17, wherein transmitting the one or more uplink voice packets comprises: transmitting, in accordance with the uplink SPS configuration, an uplink message comprising an indication of a failure to decode a downlink voice packet of the one or more downlink voice packets.

Aspect 19: The method of any of aspects 1 through 18, further comprising: failing to decode a downlink voice packet of the one or more downlink voice packets; starting a timer associated with voice packet communication, wherein a duration of the timer is based at least in part on failing to decode the downlink voice packet; and declaring a RLF based at least in part on an expiration of the timer.

Aspect 20: The method of any of aspects 1 through 19, further comprising: refrain from monitoring a downlink control channel based at least in part on the uplink SPS configuration or the downlink SPS configuration being active.

Aspect 21: A UE for wireless communication, comprising one or more memories storing processor-executable code, and one or more processors coupled with the one or more memories and individually or collectively operable to execute the code to cause the UE to perform a method of any of aspects 1 through 20.

Aspect 22: A UE for wireless communication, comprising at least one means for performing a method of any of aspects 1 through 20.

Aspect 23: A non-transitory computer-readable medium storing code for wireless communication, the code comprising instructions executable by one or more processors to perform a method of any of aspects 1 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more control messages that indicate an uplink semi-persistent scheduling (SPS) configuration for voice traffic for the UE, a downlink SPS configuration for the voice traffic for the UE, or both; and
at least one of:
receive, in accordance with the downlink SPS configuration, one or more downlink voice packets for the UE via first downlink resources of a plurality of downlink resources indicated by the downlink SPS configuration indicated by the one or more control messages; or
transmit, in accordance with the uplink SPS configuration, one or more uplink voice packets for the UE via first uplink resources of a plurality of uplink resources indicated by the uplink SPS configuration indicated by the one or more control messages.

2. The UE of claim 1, wherein the one or more processors are individually or collectively operable to execute the code to cause the UE to:
receive, in accordance with the downlink SPS configuration, a downlink message comprising an indication of a deactivation of at least one of the uplink SPS configuration or the downlink SPS configuration.

3. The UE of claim 2, wherein a medium access control-control element (MAC-CE) comprises the indication.

4. The UE of claim 2, wherein the downlink message comprises a subpacket associated with a subpacket configuration of two or more subpacket configurations, the subpacket configuration comprising a first code rate based at least in part on the subpacket comprising voice data, and the subpacket configuration comprising a second code rate based at least in part on the subpacket comprising the indication.

5. The UE of claim 1, wherein the one or more processors are individually or collectively operable to execute the code to cause the UE to:
receive a single control message that indicates a single radio resource control (RRC) configuration comprising both the uplink SPS configuration and the downlink SPS configuration.

6. The UE of claim 1, wherein the one or more processors are individually or collectively further operable to execute the code to cause the UE to:
receive a first control message that indicates a first RRC configuration indicating the uplink SPS configuration; and
receive a second control message that indicates a second RRC configuration indicating the downlink SPS configuration.

7. The UE of claim 1, wherein the one or more processors are individually or collectively further operable to execute the code to cause the UE to:
receive a single control message that indicates a first RRC configuration indicating the uplink SPS configuration and a second RRC configuration indicating the downlink SPS configuration.

8. The UE of claim 1, wherein the one or more processors are individually or collectively further operable to execute the code to cause the UE to:
receive an initial control message indicating a set of uplink SPS configurations and a set of downlink SPS configurations, wherein the one or more control messages comprise a first indication of the uplink SPS configuration of the set of uplink SPS configurations and a second indication of the downlink SPS configuration of the set of downlink SPS configurations.

9. The UE of claim 8, wherein the downlink SPS configuration comprises at least one of: a first SPS interval, a duration of a downlink resource of the plurality of downlink resources, or a transmission time interval bundle size.

10. The UE of claim 8, wherein the uplink SPS configuration comprises at least one of: a second SPS interval, a duration of an uplink resource of the plurality of uplink resources, or a transmission time interval bundle size.

11. The UE of claim 8, wherein the one or more processors are individually or collectively operable to execute the code to cause the UE to:
receive, in accordance with the downlink SPS configuration, a downlink message for the UE comprising a third indication of one or more updated parameters for one or more downlink SPS configurations of the set of downlink SPS configurations or one or more uplink SPS configuration of the set of uplink SPS configurations, wherein receiving one or more subsequent downlink voice packets or transmitting one or more subsequent uplink voice packets is based at least in part on the one or more updated parameters.

12. The UE of claim 1, wherein the one or more processors are individually or collectively further operable to execute the code to cause the UE to:
transmit, via one or more uplink resources of the plurality of uplink resources, assistance information associated with a reception of the one or more downlink voice packets or a transmission of the one or more uplink voice packets.

13. The UE of claim 1, wherein the one or more processors are individually or collectively operable to execute the code to cause the UE to:
receive, in accordance with the downlink SPS configuration, a downlink voice packet comprising an indication of one or more updated parameters for the uplink SPS configuration or the downlink SPS configuration, wherein receiving one or more subsequent downlink voice packets or transmitting one or more subsequent uplink voice packets is based at least in part on the one or more updated parameters.

14. The UE of claim 1, wherein the plurality of downlink resources and the plurality of uplink resources comprise a plurality of time alternating downlink resources and uplink resources.

15. The UE of claim 1, wherein the one or more processors are individually or collectively operable to execute the code to cause the UE to:
transmit, in accordance with the uplink SPS configuration, an uplink message comprising an indication of a failure to decode a downlink voice packet of the one or more downlink voice packets.

16. The UE of claim 1, wherein the one or more processors are individually or collectively further operable to execute the code to cause the UE to:
fail to decode a downlink voice packet of the one or more downlink voice packets;
start a timer associated with voice packet communication, wherein a duration of the timer is based at least in part on failing to decode the downlink voice packet; and
declare a radio link failure based at least in part on an expiration of the timer.

17. The UE of claim 1, wherein the one or more processors are individually or collectively further operable to execute the code to cause the UE to:
refrain from monitoring a downlink control channel based at least in part on the uplink SPS configuration or the downlink SPS configuration being active.

18. A method for wireless communication at a user equipment (UE), comprising:
receiving one or more control messages that indicate an uplink semi- persistent scheduling (SPS) configuration for voice traffic for the UE, a downlink SPS configuration for the voice traffic for the UE, or both; and
at least one of:
receiving, in accordance with the downlink SPS configuration, one or more downlink voice packets for the UE via first downlink resources of a plurality of downlink resources indicated by the downlink SPS configuration indicated by the one or more control messages; or
transmitting, in accordance with the uplink SPS configuration, one or more uplink voice packets for the UE via first uplink resources of a plurality of uplink resources indicated by the uplink SPS configuration indicated by the one or more control messages.

19. The method of claim 18, further comprising:
receiving, in accordance with the downlink SPS configuration, a downlink message comprising an indication of a deactivation of at least one of the uplink SPS configuration or the downlink SPS configuration.

20. The method of claim 18, further comprising:
receiving a single control message that indicates a single radio resource control (RRC) configuration comprising both the uplink SPS configuration and the downlink SPS configuration.
